(19) United States
(12) Patent Application Publication
(10) Pub. No.: US 2006/0086623 A1
(43) Pub. Date: Apr. 27, 2006

(54) Time-based integrated potentiostat

(76) Inventors: Harpreet S. Narula, Gainesville, FL (US); John G. Harris, Gainesville, FL (US)

Correspondence Address: AKERMAN SENTERFITT, P.O. BOX 3188, WEST PALM BEACH, FL, 33402-3188, US

(21) Appl. No.: 11/063,266

(22) Filed: Feb. 22, 2005

Related U.S. Application Data
(60) Provisional application No. 60/545,786, filed on Feb. 19, 2004.

(51) Int. Cl. G01N 27/26

(52) U.S. Cl. 205/775; 204/406

(57) ABSTRACT

An integrated potentiostat includes a voltage controller that maintains within a predetermined range a potential between a reference electrode and a working electrode in an electrochemical cell. The integrated potentiostat further includes a capacitor that supplies or receives a current through the working electrode or reference electrode of the electrochemical cell. The rate of change of a voltage across the capacitor is functionally related to the current and thus provides a time equivalent of the current.

### STATEMENT REGARDING FEDERALLY SPONSORED RESEARCH OR DEVELOPMENT

The Government has certain rights to the invention based on National Science Foundation (NSF) award #0087676.

### CROSS-REFERENCE TO RELATED APPLICATIONS

Not applicable.

### FIELD OF THE INVENTION

The invention relates to potentiostats, and, more particularly, to low noise, low power VLSI potentiostats.

### BACKGROUND

A potentiostat is an electronic device for controlling the potential or voltage between a reference electrode and a working electrode, the reference electrode and the working electrode both being contained within an electrochemical cell. In general, the potentiostat controls the potential by inducing current in the electrochemical cell. The current flow between the reference and the working electrode can typically be measured by the potentiostat. More particularly, a potentiostat can measure electrochemical activity caused by certain reactions at the electrodes of an electrochemical cell. In a typical potentiostat, the potential between the reference electrode and the working electrode represents a controlled variable, and the current in the electrochemical cell is the measured variable.

The control and measurement capabilities provided by potentiostat makes them well suited for numerous applications. Such applications include, for example, potentiometric biosensors.

The development of micro arrays that can transmit very low level signals has increased the demand for precise chemical sensors that can accurately measure chemical activity while maintaining a fixed potential between electrodes involved in electrochemical reactions. The threat of chemical and biological terrorism has added to this already growing demand for precise chemical and biological sensors.

Relatedly, there is also increasing demand for sensors that are not only precise, but also small. It is becoming increasingly important to design portable sensors that can be integrated onto a single IC.

Some recently proposed designs for VLSI potentiostats focus on amplifying small signals and using calibration to effect measurement of the enhanced, larger signal magnitudes. For example, some proposed designs would amplify small input currents that lie in the pico-ampere (pA) range so that the currents lie in the micro-ampere (μA) range. The input currents would then be measured by calibrated measuring of the currents at the enhanced, higher current levels.

These and other designs, though, generally remain problematic. Two problems that confront the proposed dual-slope converter design, for example, include errors due to charge injection and the need for relatively complex calibration. Accordingly, a potentiostat that provides both reduced size, low power consumption, and increased accuracy is needed.

### SUMMARY OF THE INVENTION

The invention provides a time-based integrated potentiostatic that can be used for various electrochemical and biochemical measurements. As used herein, “integrated” refers to chip-based circuitry, wherein preferably all electronic components are disposed on a single die. The potentiostat, for example, can be used for an amperometric or voltametric chemical sensor. The invention further provides a technique of converting electrochemical cell currents into a time signal for amperometric measurements. By converting cell currents directly into time, amplifying circuitry can be eliminated, matching problems can be avoided, and savings of chip area and power consumption can be realized. Analog signals can be processed and digital, or pulsed, outputs generated without the need for an A/D converter. Potentiostats according to the invention thus reduce the cost, size, power consumption and weight of electrolytic instrumentation.

The potentiostat circuit according to the invention accepts an electrical signal, proportional to current flowing through the electrolyte in the electrochemical cell and measures the time it takes to charge or discharge a capacitor. The sources of noise and mismatch are essentially eliminated by directly converting input current into time and then performing a time-based computation. The invention enables the measurement of currents as low as 1 pA. Additionally, bidirectional currents generated in reduction and oxidation reactions can be detected using a single design.

An integrated potentiostat, according to one inventive embodiment, can include a voltage controller for maintaining within a predetermined range a potential between a reference electrode and a working electrode in an electrochemical cell. The integrated potentiostat further can include a capacitor for supplying or receiving a current through the working or reference electrode of the electrochemical cell. The rate of change of a voltage across the capacitor is functionally related to the current and, thus, it provides a time equivalent of the current.

Another embodiment is a bidirectional integrated potentiostat. The bidirectional potentiostat can include first and second voltage controllers for maintaining within a predetermined range a potential between a reference electrode and a working electrode in an electrochemical cell. The bidirectional potentiostat additionally can include a first capacitor electrically connected to the reference electrode for supplying a current through the reference electrode. The a rate of change of a voltage across the first capacitor is functionally related to the current supplied and thereby provides a time equivalent of the current supplied. The bidirectional potentiostat further can include a second capacitor electrically connected to the working electrode for receiving a current through the working electrode. The rate of change of a voltage across the second capacitor is functionally related to the current received and thereby provides a time equivalent of the current received.

Still another inventive embodiment is a method for generating a time equivalent of a current through an electrode of an electrochemical cell. The method can include maintaining within a predetermined range a voltage between a reference electrode contained in the electrochemical cell and a working electrode contained in the electrochemical cell. The method further can include passing a current to or from the electrochemical cell through the working or reference electrode to thereby discharge or charge a capacitor. The rate of change of a voltage across the capacitor is functionally related to the current. Thus the rate provides a time equivalent of the current.

### BRIEF DESCRIPTION OF THE DRAWINGS

A fuller understanding of the present invention and the features and benefits thereof will be obtained upon review of the following detailed description together with the accompanying drawings, in which:

FIG. 1 is a schematic diagram of a potentiostat, according to an embodiment of the invention;

FIG. 2 is a schematic diagram of a potentiostat, according to another embodiment of the invention;

FIG. 3 is a schematic diagram of a potentiostat, according to yet another embodiment of the invention;

FIG. 4 is a schematic diagram of a potentiostat, according to still another embodiment of the invention;

FIG. 5 is a plot of simulation results obtained showing a capacitor voltage (C_{d}) vs. time taken by the input current to discharge the capacitor shown in FIG. 1;

FIG. 6 is a schematic diagram on a potentiostat, according to yet another embodiment of the invention;

FIG. 7 is a plot illustrating the effect of dynamically varying the reference voltage of a potentiostat including a comparator, according to yet another embodiment of the invention;

FIG. 8 is a schematic diagram of a potentiostat, according to still another embodiment of the invention;

FIG. 9 is a schematic diagram of an exemplary triangular wave generator for use in a potentiostat, according to yet another embodiment of the invention;

FIG. 10 is a schematic diagram of input waveform generated for cyclic voltammetry measurements using the exemplary triangular waveform generator in a potentiostat, according to an embodiment of the invention; and

FIG. 11 is a schematic diagram of an operational transconductance amplifier used in a potentiostatic circuit and optimized for input noise, according to still another embodiment of the invention.

### DETAILED DESCRIPTION

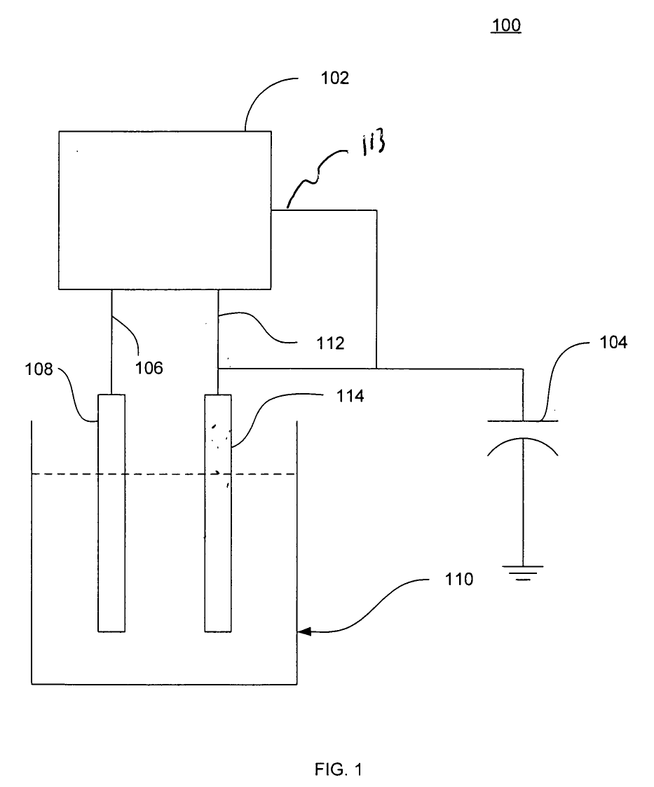

FIG. 1 is a schematic diagram of a potentiostat 100, according to one embodiment of the invention. The potentiostat 100 illustratively includes a voltage controller 102, and, electrically connected to the voltage controller, a capacitor 104. The voltage controller 102 illustratively has a first input 106 that electrically connects to a reference electrode 108 in an electrochemical cell 110. The voltage controller 102 further illustratively includes a second input 112 that electrically connects to a working electrode 114 in the same electrochemical cell 110. Second input 112 is connected to the output of the voltage controller 113. Working electrode 114 is also electrically connected to the capacitor 104 of the potentiostat 100.

According to one embodiment, the voltage controller 102 comprises a current conveyor. The current conveyor, for example, can be a class-II current conveyor, as will be readily understood by one ordinary skill in the art. Alternatively, the voltage controller 102 can be an operational amplifier. According to still another embodiment, that voltage controller 102 can be operational transconductance amplifier (OTA).

Operationally, the voltage controller 102 maintains the potential between the reference electrode 108 and the working electrode 114 so that the potential difference stays within a predetermined range. The predetermined range within which the voltage controller 102 maintains the potential can be a relatively narrow voltage range. Indeed, for many uses, the voltage controller 102 will maintain the potential difference between the reference electrode 108 and working electrode 114 at an essentially constant value.

Even brief changes in the amount of charge at an electrode (108 or 114) within electrochemical cell 110 induces a flow of current within the electrochemical cell 110 so that potential difference between the reference electrode 108 and the working electrode 114 is maintained as described already. In the potentiostat 100 shown in FIG. 1, this current causes a change in the voltage across the capacitor 104 since it is electrically connected to the working electrode 114. Therefore, the rate of change of the voltage across the capacitor 104 is functionally related to this cell current. As described herein, it is this relationship between the voltage across the capacitor 104 and the current in the electrochemical cell 110 that provides the basis for converting current, as a signal input, into a time signal. The latter providing a measurable variable that provides an indication of the current in the electrochemical cell 110 for making amperometric electrochemical, biochemical, and related measurements, as described herein.

More particularly, the voltage across the capacitor 104 and the current in electrochemical cell 110 can be functionally related by a linear relationship. The linear relationship can be defined by the following equation:

$$Δ t = \frac{C Δ V}{{I}_{pot}} , \qquad ( 1 )$$

where Δt represents a change in time, C represents a capacitance of capacitor 104, ΔV represents a change in the voltage across capacitor 104, and Iₚₒₜ represents the current in electrochemical cell 110.

According to one embodiment, the capacitor 104 is initially charged and as current flows into the electrochemical cell 110, the current flows through working electrode 114 as the capacitor 104 connected thereto discharges. That is, in discharging, the charged capacitor 104 supplies a current to the working electrode 114, and through the working electrode 114 into the electrochemical cell 110. In as much as the rate of change of the voltage across the capacitor 104 is functionally related to the current, the time for the voltage across the capacitor to decrease by some amount gives a time equivalent of the current through the working electrode 114, and, accordingly, the current flowing in electrochemical cell 110.

In another embodiment, the capacitor 104 is initially not charged, but rather receives a charge as current flows out of the electrochemical cell 110. The current which flows through the working electrode 114 is received by capacitor 104. Again, because the rate of change of the voltage across the capacitor 104 is functionally related to the current, the time for the voltage across the capacitor to increase by some amount gives a time equivalent of the current through the working electrode 114, and, thus the current flowing in electrochemical cell 110.

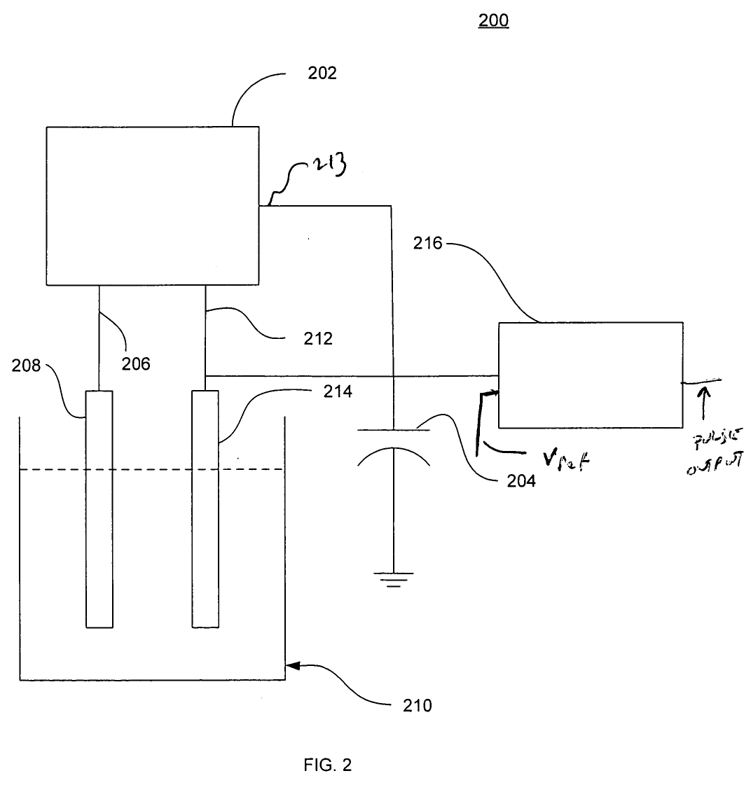

Referring now to FIG. 2, a potentiostat 200 according to another embodiment of the invention is shown which includes a voltage controller 202 and a capacitor 204. The voltage controller has first and second inputs 206, 212 that connect, respectively, to the reference electrode 208 and the working electrode 214 of an electrochemical cell 210. The output of voltage controller 213 is connected to second input 212. The capacitor 204 is additionally connected to the working electrode 214 as shown. Additionally, as further illustrated, the capacitor 204 is coupled to a comparator 216. Operatively, using reference voltage (V_{ref}) the comparator 216 converts the voltage across the capacitor 204 into a pulse output.

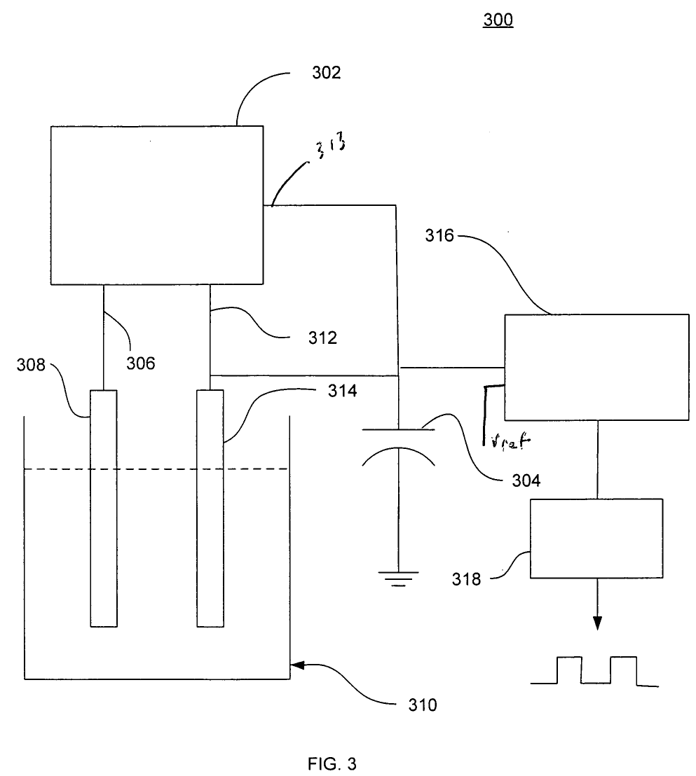

FIG. 3 represents still another embodiment of a potentiostat 300. The potentiostat 300 includes a voltage controller 302 having first and second inputs 306, 312 that connect, respectively, to the reference electrode 308 and the working electrode 314 of an electrochemical cell 310. The output of the voltage controller 313 is connected to second input 312. The potentiostat 300 further includes a capacitor 304 connected to the working electrode 314. The capacitor is also connected to a comparator 316, which, using a reference voltage (V_{ref}), converts the voltage across the capacitor 304 into a pulse output.

As also illustrated, the potentiostat 300 according to this embodiment further includes a counter 318, such as a digital counter. The counter 318 receives the pulses generated by the comparator 316. The counter 318, moreover, is calibrated to determine the current from the pulses so generated. As explained more fully below, the timing of the pulses can be used to determine a time equivalent of the current in the electrochemical cell 310.

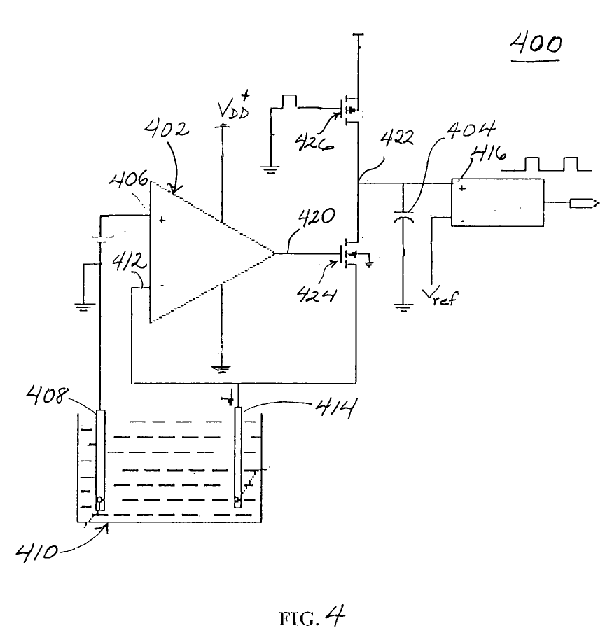

FIG. 4 is a schematic diagram of an integrated potentiostat 400, according to still another embodiment of the invention. The potentiostat 400 is shown together with an electrochemical cell 410 in which there is reference electrode 408 and working electrode 414. The potentiostat 400 includes a voltage controller, which as illustrated is an operational transconductance amplifier (OTA) 402 that converts a voltage applied at a non-inverting terminal 406 to an output current. An inverting terminal 412 of the OTA 402 is connected to the working electrode 414, and the reference electrode 408, as illustrated, is grounded. The potentiostat 400 thus conveys the input current at the inverting terminal 412 to a high-impedance output terminal 420 while maintaining a constant voltage at the non-inverting input terminal 406.

A capacitor 404 having a capacitance C_{d} is connected between node 422 and a ground. The capacitor 404 initially is precharged to V_{DD} through a first switch, which is illustratively a transistor 424 such as p-type metal-oxide transistor (PMOS), controlled by a signal RESET (not shown). The capacitor 404 is then discharged through a second switch, which is illustratively a transistor 426 such as an n-type metal-oxide transistor. (NMOS), the input current flowing through the working electrode 414 of the potentiostat 400. A comparator 416 is connected to the capacitor 404 provided and receives the voltage across capacitor 404 as one of its inputs. A reference voltage (V_{ref}) is used as the second input of the comparator 416, which clamps the voltage drop across the capacitor 404.

When the voltage of the capacitor 404 reaches V_{ref}, a pulse is generated at the output of the comparator 416 and the capacitor 404 returns, in response to the RESET signal, to voltage V_{DD} through the switch 426 (illustratively, the PMOS transistor). The time taken for the output of the comparator 416 to change between the respective levels, gives the time equivalent of the current input at the working electrode 414. The potentiostat 400 can eliminate quantization errors and requires only one comparator as opposed to an entire A/D converter on a chip, as with conventional potentiostat techniques and devices.

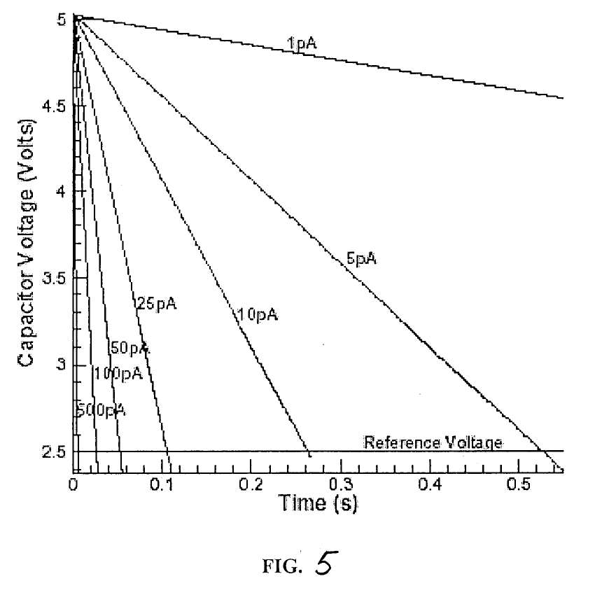

FIG. 5 provides simulation results in which the voltage, C_{d}, of the capacitor 404 in FIG. 4 is plotted against the time (in seconds) taken by the input current to discharge from the capacitor. This plot of the voltage of the capacitor 404 versus time graphically demonstrates that the discharge time depends on the magnitude of the input current. It illustrates, more particularly, that shorter times are associated with higher input currents.

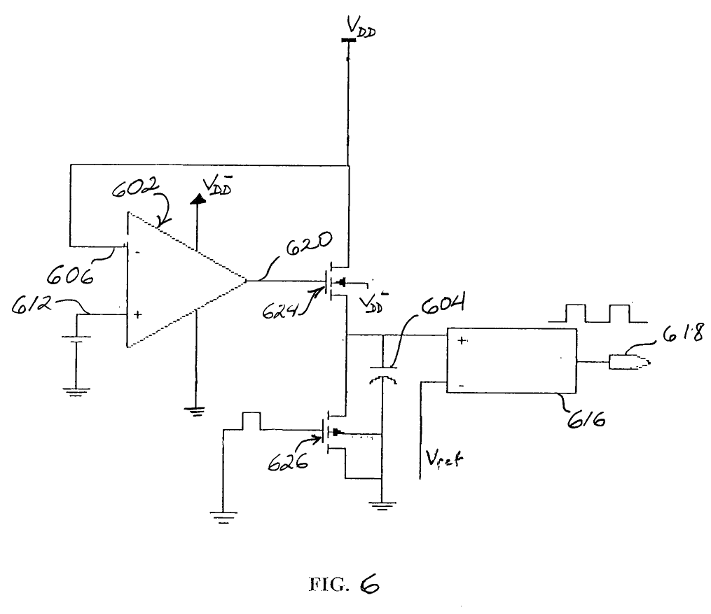

Referring now to FIG. 6, an integrated potentiostat 600 according to yet another embodiment is illustrated. The potentiostat 600 includes a voltage controller, which is illustratively an OTA 602 having first and second input terminals 606, 612. The potentiostat includes a first switch, which is shown as a PMOS transistor 624, the gate of which is connected to an output terminal 620 of the OTA 602. The potentiostat further includes a second switch, which is shown as an NMOS transistor 626.

The potentiostat 600 also includes a capacitor 604, which is charged by the input current (i.e., the current of an electrochemical cell, not shown) through the first switch, illustratively the PMOS transistor 624. In this embodiment, the capacitor 604 is charged by a negative input current through the first switch 625. The capacitor 604 is connected to a comparator 616, which converts the input current into time. In this design, the capacitor 604, having capacitance (C_{c}), is charged by the input current through the PMOS transistor 624, and when the voltage across the capacitor 604 reaches V_{ref}, a pulse is generated at the output of the comparator 616. The capacitor 604 is subsequently reset to 0V by discharging through the second switch 626, shown as a NMOS transistor.

The input current can be calculated by counting the number of pulses generated, using a digital counter 618 or other suitable device, such as a micro-controller, calibrated to count the respective pulses. It should be noted that the potentiostat 600 provides lower noise as compared, for example, to the previous circuit (potentiostat 400) since input PMOS transistors provide lower thermal noise due to the lower mobility coefficient of current carrier holes in PMOS transistors, as compared to electrons in NMOS transistors.

When a signal is small, discharging the capacitor 604 to V_{ref}=2.5V takes a relatively long time (e.g. 2.5 sec for 1 pA input current) as compared to the time taken when a relatively large current passes through the circuit (e.g. 2.5 msec for a 1 nA input current). Varying the capacitance (C) of capacitor 604, or ΔV (voltage across capacitor 604), with change in Iₚₒₜ in equation (1), above, defining a linear relationship between the current and the voltage across the capacitor 604 can bound the maximum time taken for measurements. Changing the capacitance would generally not increase the dynamic range and may also require more area on the chip for higher current inputs.

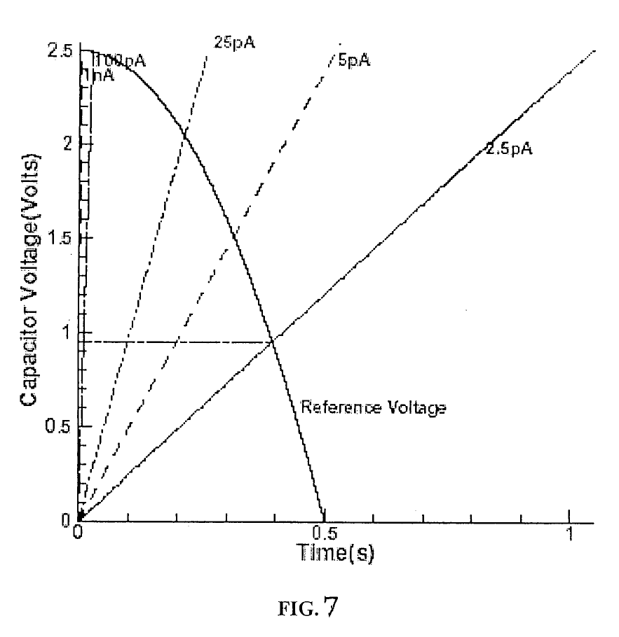

Instead, if ΔV is varied dynamically as shown in FIG. 7, the time taken for charging (or discharging for the previous potentiostat 400) the capacitor voltages generated can be reduced. Using this technique, the maximum response time of the circuit can be limited. As shown in FIG. 7, limiting the response time to 0.5 sec, ΔV=reference voltage=0.95V for 2.5 pA input current. Thus, significant improvement is achieved in the dynamic range of the signals within this time range.

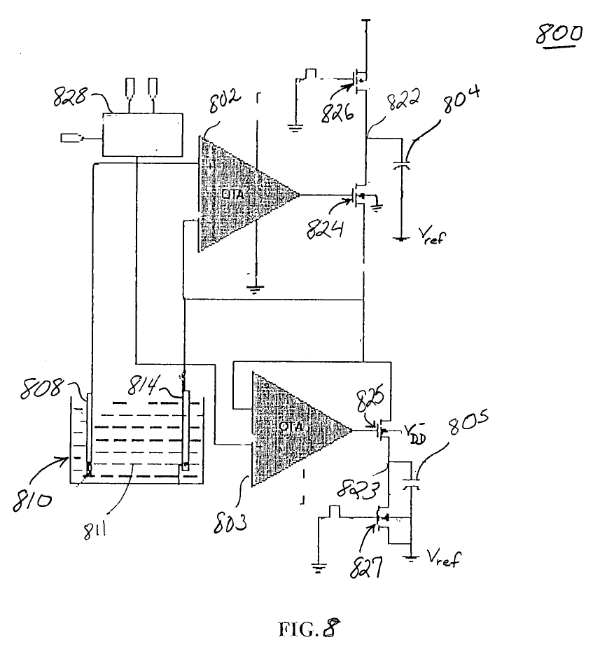

The previous circuits (potentiostat 400 and potentiostat 600) can be integrated into a single circuit, such as on a single die, to control both positive and negative currents, as generated, for instance in oxidation and reduction reactions. A potentiostat for measuring both positive and negative current, is illustrated by the schematic diagram of FIG. 8. The potentiostat 800 is capable of detecting bidirectional flow of small currents flowing through electrolyte 811 in electrochemical cell 810. The potentiostat 800 is defined herein as a bidirectional flow potentiostat.

The bidirectional potentiostat 800 illustratively comprises a first voltage controller 802 and a second voltage controller 803. As illustrated, both the first and second voltage controllers 802, 803 each have an input terminal that connects to a reference electrode 808 of an electrochemical cell 810 and another input terminal that connects to a working electrode 814 of the electrochemical cell 810.

The bidirectional potentiostat 800 further includes a first capacitor 804 that is electrically connected to the working electrode 814 of the electrochemical cell 810 for discharging so as to induce a current through the working electrode to the electrochemical cell 805. The bidirectional potentiostat 800 additionally includes a second capacitor 805 that is also electrically connected to the working electrode 814 of the electrochemical cell 810. The second capacitor 805 is charged by current from the electrochemical cell 810, specifically, the current flowing through the working electrode 814 to the second capacitor 805.

With respect to the first capacitor 804, the rate of change of a voltage across the first capacitor 804 is functionally related to a current that flows through the reference electrode 808 to the electrochemical cell 810. With respect to the second capacitor 805, the rate of change of a voltage across the second capacitor is functionally related to a current that flows from the electrochemical cell through the working electrode 814.

As illustrated, an output terminal of the first voltage controller 802 connects to a switch, which as illustrated is an NMOS transistor 824. The switch is connected at a node 822, which is coupled to first capacitor 804. Another switch, which as illustrated is a PMOS transistor 826, is connected to a first node 822. Similarly, an output terminal of the second voltage controller 803 connects to a switch, this switch being a PMOS transistor 825, which is connected to second node 823. The second capacitor 805 is connected to the second node 823. Another switch, which as illustrated is an NMOS transistor 827, is connected to the second node 823.

For oxidation reactions, positive currents flow into the electrolyte 811. In this case, the first capacitor 804 discharges through the NMOS transistor 824 connected at node 822. Current flows in an opposite direction for the PMOS transistor 825 connected to the second node 823, and thus it will be switched off during oxidation.

For reduction reactions, negative currents flow out of the working electrode 814 and through the PMOS transistor 825 thereby charging to second capacitor 805 with the input current. During reduction, NMOS transistor 824 is switched off.

A comparator (not shown), as described above, can be connected to one or both of the first and second capacitors 804, 805 for generating a pulse based upon a voltage across one or both of the capacitors. Additionally, a counter (also not shown) as described above can be connected to one or more comparators so connected for counting the pulses generated. As described, a counter can be a digital counter.

In order to generate a cyclic voltammogram for an electrolytic reaction, a triangular waveform generator 828, such as a digital waveform generator or other on-chip digital circuit, can be included in the potentiostat 800 to generate triangular waveforms. The range of the potential can scanned starting at an initial potential (Vₗₒ) and ending at a final potential (Vₕᵢ). The input to the potentiostat Vₚₒₜ is then changed as a linear function of time. The rate of change of the potential with time (termed a scan rate) is set by changing the bias current (I_{b}) used to charge/discharge the appropriate capacitor.

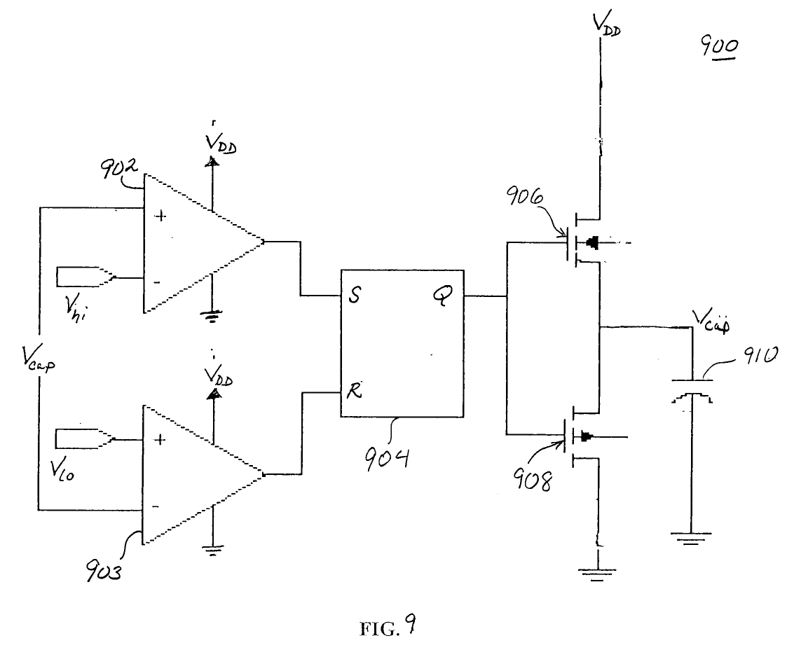

An exemplary triangular waveform generating circuit 900 is shown in FIG. 9. As illustrated, the circuit 900 includes a first and second comparator 902, 903. The circuit 900 further includes a switch, which is illustratively an RS-latch 904. An output terminal of the first comparator 902 is connected to the (S) set terminal of the RS-latch 904, and the output terminal of the second comparator 903 is connected to the (R) reset terminal of the RS-latch. As further illustrated, the output (Q) of the RS-latch 904 is connected to the gates of a NMOS and a PMOS transistor 906, 908. A capacitor 910 is connected between the transistors as further shown.

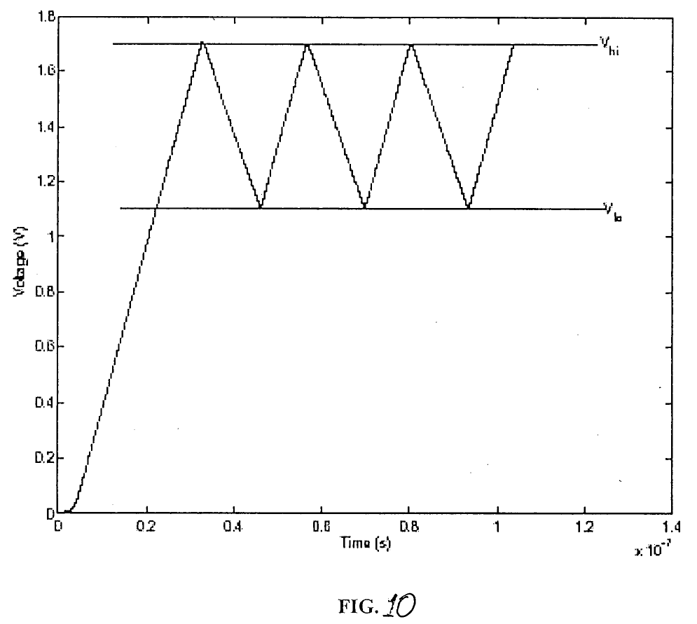

The first and second comparators 902, 903 should be fast enough so that the output state changes rapidly so as the triangular wave reaches Vₕᵢ or Vₗₒ so that triangular waveform is confined in their specified range. A high-speed strobed comparator, for example, can be used. The delay involved during the comparison of Vₕᵢ with the voltage on the capacitor 910 is estimated to be around 4.5 ns from simulation results obtained for a particular embodiment. The corresponding delay on the other direction is 4.3 ns. Depending upon bias current, error can typically be reduced so that it is within the tolerance of the circuit. Comparator output, as shown, is supplied to the SR-latch, the output of which controls the transistors 906, 908. One these two transistor is always OFF. The bias current (I_{b}) can generated using a single source and mirrored using modified Wilson current mirrors (not shown in the diagram). An exemplary waveform generated for cyclic voltammetry measurements by the triangular waveform generator is shown in FIG. 10.

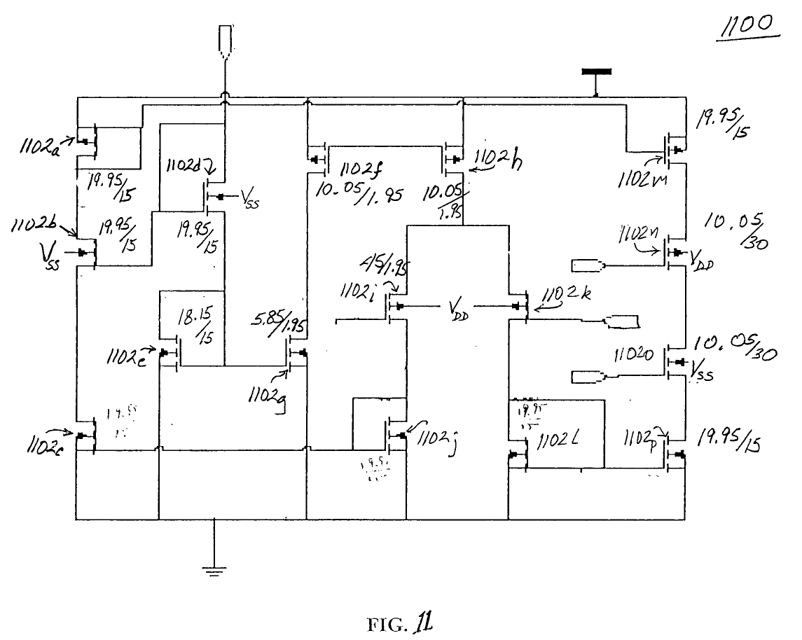

Two important problems related to the design of a time-based converter are input noise and propagation delay of the comparator. FIG. 11 is a schematic diagram of an operational transconductance amplifier 1100 optimized for input noise, according to still another embodiment of the invention. As illustrated, the operational transconductance amplifier 1100 comprises a plurality of metal-oxide transistors 1102a-1102p.

Proper sizing of the transistors is important for achieving low noise at low current levels. Exemplary dimensions in W/L format are shown next to each transistor. With the bias current set at 5 μA, the transistors 1102a-1102p may operate in either the weak or strong inversion region depending on their width/length (W/L) ratios.

An analysis of the operational transconductance amplifier 1100 circuit yields the input referred thermal noise power, which is calculated to be:

$${v}_{ni , thermal}^{2} = \frac{8 ktγ}{{g}_{m 1}} [ 1 + \frac{2 {g}_{m 3}}{{g}_{m 1}} + \frac{{g}_{m 7}}{{g}_{m 1}} ] \qquad ( 2 )$$

The transistors, whose W/L ratios are as indicated in FIG. 11, are sized such that the relevant transconductance parameters satisfy the relation gₘ₃, gₘ₇<<gₘ₁, so as to minimize the noise contribution of devices 1102i-1102p. The actual W/L values for the various transistors can be determined through minimizing noise using a standard simulation tool. This pushes transistors 1102i-1102p into strong inversion where their relative transconductance gₘ/I_{D} decreases as 1/\sqrt{I_{D}}. In practice, gₘ₃ and gₘ₇ can not be decreased beyond certain limits without danger of instability. At the same time all transistors must be made as large as possible to minimize 1/f noise and increase the Early voltage. In this way, the transistor sizes can be optimized for minimizing noise.

The propagation delay of a comparator is caused by input offset, sensitivity to differential signal, speed and input capacitance of comparator. The input offset voltage of the comparator results in the final capacitor voltage V_{final}, required to generate a proper pulse at the output of the comparator, to be little more (or less) than V_{ref}. This difference in time is due to the comparator offset given by:

$$\pm {t}_{off} = {t}_{final} - {t}_{ideal} = \frac{{CV}_{off}}{{I}_{inp}} \qquad ( 3 )$$

where V_{off}=V_{final}−V_{ref}. In order to eliminate, or at least substantially reduce, these possible sources of error, a high-speed CMOS comparator with 8-bit resolution has been used in the design. The design performs the comparison directly by means of regeneration resulting in substantial reduction in delay, power consumption and die area which is critical for our design application. Using Level 49 SPICE parameters and process variability estimates, the total offset (systematic plus random) was calculated to be 5 mV(max). This means that delay error t_{off} is always less than 0.2% of the total time.

The resolution of this design depends upon the smallest change in input current that can be detected around a specific current range. This is given by:

$$δ t = C ( V ( t ) - {V}_{0} ) ( \frac{δ i}{i ( i + δ i )} ) \qquad ( 4 )$$

where δt and δi are the change in charging/discharging time and the minimum resolved change in current. V₀ is the initial voltage on the capacitor and V(t) is the voltage at time t. The smallest change in current that can be sensed depends upon the smallest time difference that can be detected. Currents with resolution of 100 fA were possible to measure using the prototype chip.

From the above discussion, it can be seen that transistor sizing is particularly important for the low-current operation if noise is to be minimized. Standard simulation tools can determine appropriate W/L ratios for transistors comprising the potentiostat to minimize noise.

In addition, for cyclic voltammetry application, the input current is continually changing. Accordingly, a method for bandlimited signal reconstruction is required. For example, bandlimited reconstruction can be achieved by low-pass filtering the weighted output pulse train from the potentiostat. Since the integral of the input current between consecutive spikes equals the capacitance times the reference voltage, a system of linear equations can be written that constrain the weight values. A pseudo-inverse technique can then be used to invert the resulting linear systems to derive the appropriate weighting coefficients.

Potentiostats according to the invention provide a novel solution for next generation electrochemical testing. Existing potentiostats are bulky and costly. The inventive design is portable, economical, and typically provides better performance in comparison to conventional designs.

Although the invention has been described for use as a potentiostat to perform electrochemical tests such as for high precision amperometry and voltammetry, the invention also can be used to detect electrochemical activity in any liquid, such as glucose or blood. Since the circuit is small, the invention can be used as a high quality hand-held potentiostat which can be reliably used for wet-chemical testing in research labs and for a variety of other commercial applications. For example, the invention can be integrated into an array of sensors performing different tasks at the same time, such as for a sensor design to improve homeland security by detecting biological and chemical threats.

### EXAMPLES

It should be understood that the example and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof.

A prototype chip was fabricated through MOSIS in the AMI 0.5 μm CMOS process. For testing flexibility, reference currents and non-critical digital circuits, off-chip components were used.

It was observed that the actual chip performs as designed for current inputs above 1 pA, while it takes a relatively long time to charge the capacitor as the input current reaches 1 pA and below. The difference between the measured and ideal results below 1 pA input current is likely attributed to parasitic capacitance of a comparator and buffer added in the chip for testability of the design. As the gate voltage of the input transistors of the comparator reaches saturation, the input gate capacitance increases which causes the input current to take more time to charge or discharge the capacitor. This increase in capacitance is equivalent to requiring about 100 fA of extra current to charge or discharge the capacitor in the desired time according to equation 1 and has a noticeable effect when input currents less than 2 pA are measured. It is observed that a little extra delay at each data point remains a constant percent of input current which can be easily eliminated by calibrating the capacitor at the output of the current conveyor.

Simulations demonstrate that currents from 1 pA to 200 nA can be detected with maximum error of ±0.1% due to non-linearity. The inventive design has a minimum resolvable current of 100 fA for full scale current of 200 nA. Minimum current detected using the design with PMOS transistor at the input was 300 fA.

It is to be understood that while the invention has been described in conjunction with the preferred specific embodiments thereof, that the foregoing description as well as the examples are intended to illustrate and not limit the scope of the invention. Other aspects, advantages and modifications within the scope of the invention will be apparent to those skilled in the art to which the invention pertains.

We claim:

1. An integrated potentiostat comprising:
a voltage controller for maintaining within a predetermined range a potential between a reference electrode and a working electrode in an electrochemical cell, a first input of said voltage connector connected to said reference electrode and a second input of said voltage controller connected to said working electrode; and
a capacitor coupled to said working electrode for supplying or receiving a current through said reference or working electrode, wherein a rate of change of a voltage across said capacitor is functionally related to the current and thereby provides a time equivalent of said current.

2. The integrated potentiostat of claim 1, wherein said capacitor is coupled to a comparator for converting the voltage across said capacitor into pulses.

3. The integrated potentiostat of claim 2, further comprising a counter coupled to said capacitor for receiving the pulses, said counter calibrated to determine the current based upon the pulses.

4. The integrated potentiostat of claim 1, wherein said functional relationship is a linear relationship.

5. The integrated potentiostat of claim 4, wherein the linear relationship is defined by the equation
$$Δ t = \frac{C Δ V}{{I}_{pot}} ,$$
where Δt represents a change in time, C represents a capacitance of said capacitor, ΔV represents a change in the voltage across said capacitor, and Iₚₒₜ represents said current.

6. The integrated potentiostat of claim 1, wherein said voltage controller comprises a current conveyor.

7. The integrated potentiostat of claim 1, wherein said voltage controller comprises an operational amplifier.

8. The integrated potentiostat of claim 1, wherein said voltage controller comprises an operational transconductance amplifier.

9. The integrated potentiostat of claim 1, further comprising a transistor connected between said voltage controller and said capacitor.

10. A bidirectional integrated potentiostat comprising:
first and second voltage controller coupled to a reference electrode of an electrochemical cell and a second voltage controller coupled to a working electrode of said electrochemical cell, said first and second voltage controllers for maintaining within a predetermined range a potential difference between said reference electrode and said working electrode in said electrochemical cell;
a first capacitor electrically connected to said reference electrode for supplying a current through said reference electrode, wherein a rate of change of a voltage across said first capacitor is functionally related to the current supplied and thereby provides a time equivalent of the current supplied; and
a second capacitor electrically connected to said working electrode for receiving a current through said working electrode, wherein a rate of change of a voltage across said second capacitor is functionally related to the current received and thereby provides a time equivalent of the current received.

11. The bidirectional potentiostat of claim 10, further comprising a triangular waveform generator for generating a triangular waveform based upon the current supplied and the current received.

12. The bidirectional potentiostat of claim 10, further comprising at least one comparator connected to at least one of said first and second capacitors.

13. The bidirectional potentiostat of claim 10, further comprising a first switch connected between said first voltage controller and said first capacitor, and a second switch between said second voltage controller and said second capacitor.

14. The bidirectional potentiostat of claim 13, wherein said first switch comprises an n-type metal-oxide transistor, and said second switch comprises a p-type metal-oxide transistor.

15. A method for generating a time equivalent of a current flowing in an electrode of an electrochemical cell, the method comprising:
maintaining within a predetermined range a voltage between a reference electrode contained in the electrochemical cell and a working electrode contained in the electrochemical cell;
passing a current to or from the electrochemical cell through the working electrode or reference electrode to discharge or charge a capacitor, wherein a rate of change of a voltage across the capacitor is functionally related to the current and thereby provides a time equivalent of the current.

16. The method of claim 15, further comprising the step of converting the voltage across the capacitor into pulses.

17. The method of claim 16, further comprising the step of timing at least one of the duration of and intervals between the pulses, wherein the time equivalent of the current is based upon the timing of the pulses.
